(19) United States
(12) Patent Application Publication
(10) Pub. No.: US 2025/0294097 A1
(43) Pub. Date: Sep. 18, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Tsutomu Udaka, Kanagawa (JP); Ryosuke Nara, Kanagawa (JP); Tatsuro Matsuoka, Kanagawa (JP)

(73) Assignee: FUJIFILM Business Innovation Corp., Tokyo (JP)

(21) Appl. No.: 18/770,934

(22) Filed: Jul. 12, 2024

(30) Foreign Application Priority Data
Mar. 18, 2024 (JP) 2024-042848

(51) Int. Cl. H04N 1/00

(52) U.S. Cl. CPC H04N 1/00029; H04N 1/00079

(57) ABSTRACT

An information processing system includes a processor configured to: perform diagnosis regarding whether an abnormal noise is produced in the information based on an instruction from a user; identify a cause of the abnormal noise when the abnormal noise is produced, and display the cause as a result of the diagnosis; and when the diagnosis result includes an indication that the abnormal noise is produced and the cause, notify the user of an indication that the cause of the abnormal noise is able to be addressed without requiring an operation of the user, is able to be addressed through the operation of the user, or requires a countermeasure to be taken by a customer engineer.

### CROSS-REFERENCE TO RELATED APPLICATIONS

This application is based on and claims priority under 35 USC 119 from Japanese Patent Application No. 2024-042848 filed Mar. 18, 2024.

### BACKGROUND

### (i) Technical Field

The present disclosure relates to an information processing system and a non-transitory computer readable medium.

### (ii) Related Art

Japanese Unexamined Patent Application Publication No. 2004-233583 discloses a multifunction peripheral that checks a state of the multifunction peripheral, stops an operation when an abnormality is detected, and displays display information selected from a plurality of pieces of display information according to the number of times the abnormality has occurred when displaying abnormality information, thereby switching the notification content between a case of an abnormality due to a hardware failure and a case of an accidental abnormality.

Japanese Patent No. 3831143 discloses a management service system in which a plurality of image forming apparatuses and a management apparatus that remotely manages the plurality of image forming apparatuses are connected to each other via a communication line, and when the management apparatus receives a request for inspection for an image forming apparatus from a terminal device at a service location, time-series data on the state of the image forming apparatus that is the target of the request is acquired and analyzed to diagnose the presence or absence of an abnormality. When it is diagnosed that there is an abnormality, a maintenance or repair request for the image forming apparatus is issued to the terminal device at the service location.

Japanese Patent No. 7117573 discloses a sound state display system that collects sound emitted from an inspection target to acquire the sound as sound data, and analyzes the acquired sound data to perform diagnosis regarding the presence or absence of abnormality in the inspection target.

### SUMMARY

In an information processing apparatus such as an image forming apparatus, an abnormal noise may be produced due to, for example, deterioration of mechanical components as a result of wearing. When a user of the information processing apparatus recognizes such an abnormal noise produced, the user contacts a customer engineer (hereinafter, abbreviated as CE) of the manufacturer of the information processing apparatus, and requests the CE to address the cause of the abnormal noise. However, there are a case where, even when the customer engineer visits the installation place of the information processing apparatus, no abnormal noise is actually produced, a case where the abnormal noise is caused by how the user is handling the apparatus, and a case where the user him or herself can stop the abnormal noise with a simple operation. In such cases, if the user who has recognized the abnormal noise produced can address the cause of the abnormal noise without contacting the customer engineer, the customer engineer does not need to wastefully visit the installation place of the information processing apparatus.

Aspects of non-limiting embodiments of the present disclosure relate to an information processing system and a program capable of reducing the frequency of contact made to the customer engineer as compared with a case where a user who has recognized the abnormal noise produced immediately contacts the customer engineer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to:
perform diagnosis regarding whether an abnormal noise is produced in the information processing system based on an instruction from a user;
identify a cause of the abnormal noise when the abnormal noise is produced, and display the cause as a result of the diagnosis; and
when the diagnosis result includes an indication that the abnormal noise is produced and the cause, notify the user of an indication that the cause of the abnormal noise is able to be addressed without requiring an operation of the user, is able to be addressed through the operation of the user, or requires a countermeasure to be taken by a customer engineer.

### BRIEF DESCRIPTION OF THE DRAWINGS

Exemplary embodiments of the present disclosure will be described in detail based on the following figure(s), wherein:

FIG. 1 is a diagram illustrating a system configuration of an information processing system according to an exemplary embodiment of the present disclosure;

FIG. 2 is a block diagram illustrating a hardware configuration of an image forming apparatus 10 according to the exemplary embodiment of the present disclosure;

FIG. 3 is a block diagram illustrating a functional configuration of the image forming apparatus 10 according to the exemplary embodiment of the present disclosure;

FIG. 4 is a diagram illustrating an example of a frequency spectrum waveform generated when operation sound is acquired;

FIG. 5 is an example of a home screen displayed on an operation panel 50 of the image forming apparatus 10 according to the exemplary embodiment of the present disclosure;

FIG. 6 is a flowchart illustrating an operation performed when self-diagnosis regarding whether abnormal noise is produced is performed in response to an operation on an operation icon 51 “abnormal noise diagnosis” on the home screen illustrated in FIG. 5;

FIG. 7 is a diagram illustrating an example of a display screen in a case of displaying on the operation panel 50, a message indicating that no abnormal noise is produced;

FIG. 8 is a diagram illustrating an example of a display screen which is displayed when abnormal noise is detected and the cause of the detected abnormal noise is self-repairable;

FIG. 9 is a diagram illustrating an example of a display screen in a case of displaying, on the operation panel 50, a message indicating that an abnormal noise has been stopped by self-repair;

FIG. 10 is a diagram illustrating an example of a display screen which is displayed on the operation panel 50 in a case where the abnormal noise has failed to be stopped by self-repair;

FIG. 11 is a diagram illustrating an example of a display screen in a case of displaying a countermeasure for stopping abnormal noise is displayed on the operation panel 50 when the cause of the abnormal noise can be addressed by the user;

FIG. 12 is a diagram illustrating an example of a display screen in a case of displaying, on the operation panel 50, a message indicating that an abnormal noise has been stopped by a user's operation;

FIG. 13 is a diagram illustrating an example of a display screen to be displayed on the operation panel 50 when the abnormal noise fails to be stopped by the countermeasure taken by the user;

FIG. 14 is a diagram illustrating an example of a display screen to be displayed on the operation panel 50 when the detected cause of the abnormal noise cannot be self-repaired or addressed by the user; and

FIG. 15 is a diagram illustrating an example of a display screen to be displayed on the operation panel 50 when the cause of the detected abnormal noise cannot be self-repaired or addressed by the user but is a minor abnormal noise with a low abnormal noise level.

### DETAILED DESCRIPTION

Next, exemplary embodiments of the present disclosure will be described in detail with reference to the drawings.

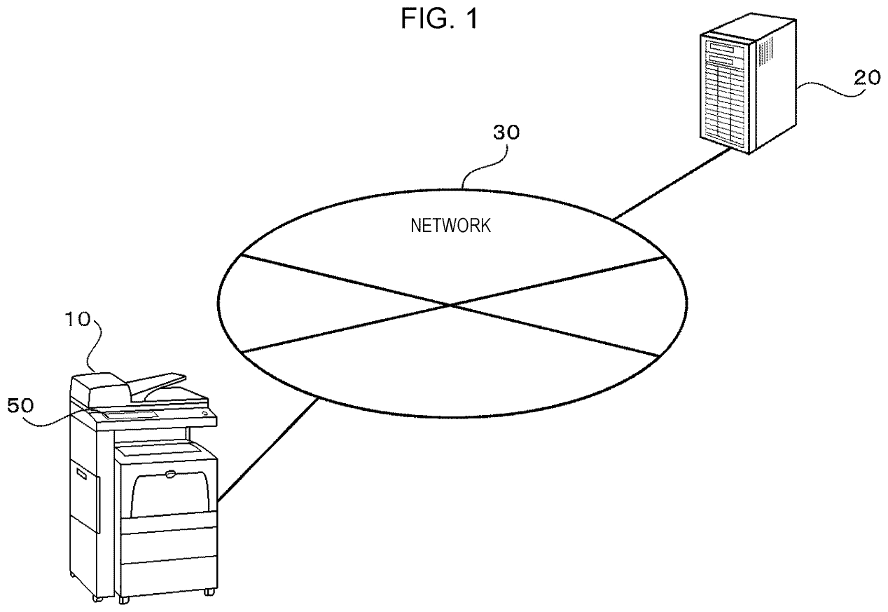

FIG. 1 is a diagram illustrating a system configuration of an information processing system according to an exemplary embodiment of the present disclosure.

As illustrated in FIG. 1, the information processing system according to an exemplary embodiment of the present disclosure includes an image forming apparatus 10 and a management server 20 installed in a call center or the like, which are connected to each other via a network 30 such as the Internet. The image forming apparatus 10 is an information processing apparatus having a plurality of functions such as a printing function, a scan function, a copy function, and a facsimile function, and is an apparatus so-called a multifunction peripheral. The image forming apparatus 10 is provided with an operation panel 50, and can receive an operation from a user and notify the user of various kinds of information via the operation panel 50.

The image forming apparatus 10 is installed and used in various places such as offices and stores for example. In a case where any malfunction occurs in the image forming apparatus 10, a maintenance worker known as a customer engineer (CE) visits a place where the image forming apparatus 10 is installed, to perform the repair. In the image forming apparatus 10, an abnormal sound (hereinafter, referred to as abnormal noise) may be produced due to deterioration of a mechanical component as a result of wearing or the like. When the user of the image forming apparatus 10 recognizes the production of such an abnormal noise, the user contacts a call center or the like to request the CE to visit the place and address the cause of the abnormal noise. However, in some cases, even when the CE actually goes to the place where the image forming apparatus 10 is installed, the abnormal noise may not be actually produced, the abnormal noise may be produced due to how the user is handling apparatus, or the abnormal noise may be stoppable by the user himself/herself through a simple operation. When the CE is requested to visit also in such a case, the CE's time is meaninglessly consumed and his or her usual maintenance operation is hindered. If the user who has recognized the production of the abnormal noise can address the cause of the abnormal noise without contacting the CE, the CE does not need to meaninglessly visit the place where the image forming apparatus 10 is installed.

Therefore, the image forming apparatus 10 of the present exemplary embodiment performs control as described below, so as to reduce the frequency of the contact made to the CE, compared with a case where the user who has recognized the production of the abnormal noise immediately contacts the CE to request for the visit.

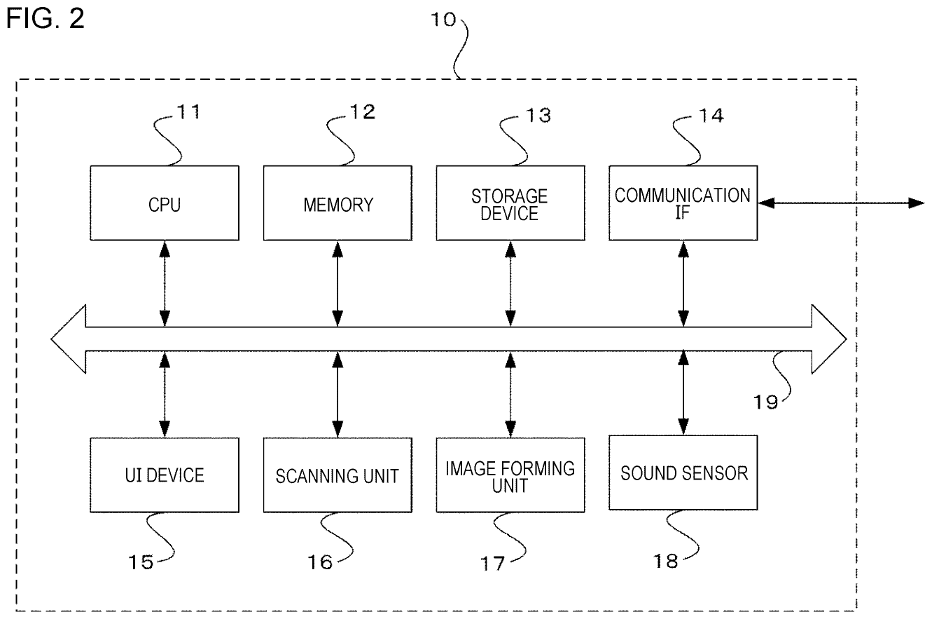

FIG. 2 illustrates a hardware configuration of the image forming apparatus 10 in the information processing system according to the present exemplary embodiment.

As illustrated in FIG. 2, the image forming apparatus 10 includes a CPU 11, a memory 12, a storage device 13 such as a hard disk drive, a communication interface (abbreviated as IF) 14 that transmits and receives data to and from an external device or the like via the network 30, a user interface (abbreviated as UI) device 15 including a touch panel or a liquid crystal display and a keyboard, a scanning unit 16, an image forming unit 17, and a sound sensor 18. These components are connected to each other via a control bus 19.

The image forming unit 17 prints an image on a recording medium, such as a printing sheet, through processes such as charging, exposure, development, transfer, and fixing. The sound sensor 18 is disposed at such a position as to detect sound information in the image forming apparatus 10. For example, the sound sensor 18 may be provided for each part in which an abnormal noise may be produced, such as the image forming unit 17, a duplex auto document feeder (DADF), a finisher, or a paper feed tray.

The CPU 11 is a processor that executes predetermined processing based on a control program stored in the memory 12 or the storage device 13 to control the operation of the image forming apparatus 10. In the present exemplary embodiment, the CPU 11 reads and executes the control program stored in the memory 12 or the storage device 13, but this is not limiting. The control program may be provided in a form of being recorded in a computer-readable recording medium. For example, the program may be provided in a form of being recorded in an optical disc such as a compact disc (CD)-ROM and a digital versatile disc (DVD)-ROM, or in a form of being recorded in a semiconductor memory such as a universal serial bus (USB) memory and a memory card. Furthermore, the control program may be acquired from an external device via a communication line connected to the communication interface 14.

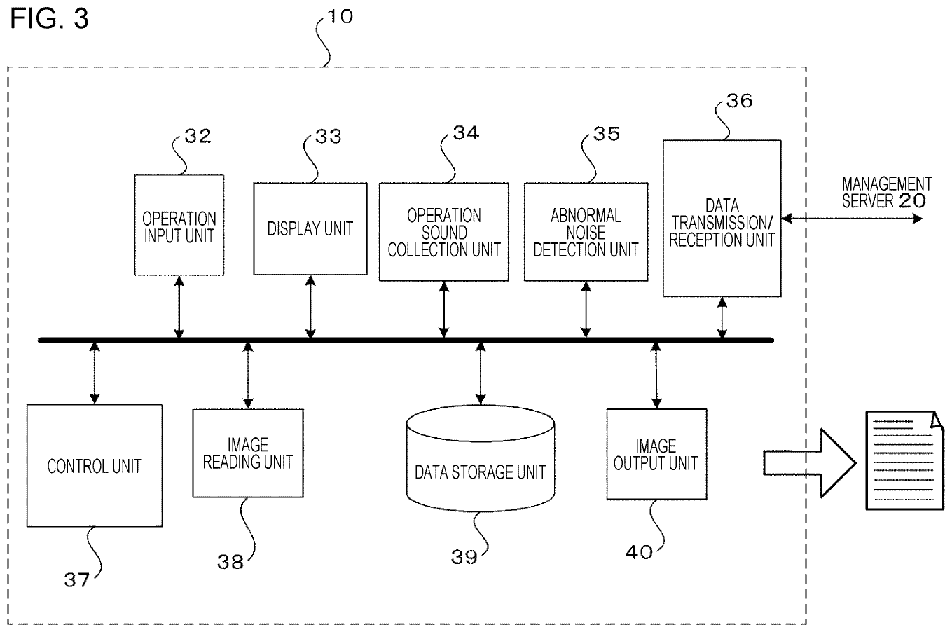

FIG. 3 is a block diagram illustrating a functional configuration of the image forming apparatus 10 implemented by execution of the above-described control program.

As illustrated in FIG. 3, the image forming apparatus 10 of the present exemplary embodiment includes an operation input unit 32, a display unit 33, an operation sound collection unit 34, an abnormal noise detection unit 35, a data transmission/reception unit 36, a control unit 37, an image reading unit 38, a data storage unit 39, and an image output unit 40.

The operation input unit 32 inputs information on various operations performed by the user. The display unit 33 is controlled by the control unit 37 and displays various types of information to the user. The data transmission/reception unit 36 transmits and receives data to and from an external device such as the management server 20.

The control unit 37 controls the image reading unit 38 and the image output unit 40 to execute various jobs such as a print job and a copy job based on a user instruction or the like input with the operation input unit 32. The data storage unit 39 stores various types of data such as print data generated by the control unit 37.

The image output unit 40 outputs an image onto a recording medium such as a printing sheet based on the control by the control unit 37. The image reading unit 38 reads a document image from a set document based on control by the control unit 37.

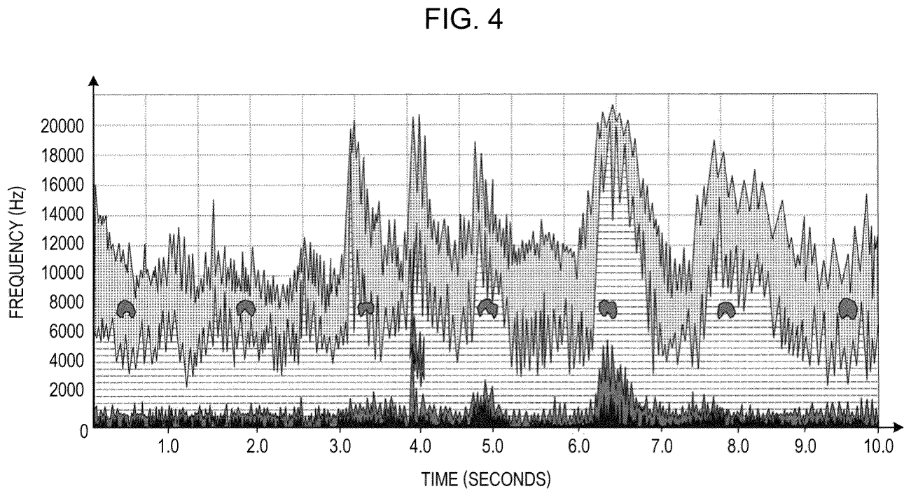

The operation sound collection unit 34 collects sound information such as an operation sound produced in the image forming apparatus 10 which is the monitoring target apparatus. Specifically, the operation sound collection unit 34 collects sound pressure value data for each predetermined frequency band in the operation sound produced when the image forming apparatus 10 executes a print job or the like. Alternatively, the operation sound collection unit 34 acquires sound information by generating a frequency spectrum image by converting sound data into a frequency spectrum waveform as illustrated in FIG. 4 for a predetermined frequency in an operation sound produced when the image forming apparatus 10 executes a print job or the like. FIG. 4 illustrates an example of the frequency spectrum waveform thus generated.

The control unit 37 stores, in the data storage unit 39, the sound information collected by the operation sound collection unit 34 together with characteristic information such as the content of the job under execution at the time of the collection of the sound information.

In the data storage unit 39 of the present exemplary embodiment, sound information in a case where various components and the like are free of abnormality and the components operate normally is stored as sound information in a normal state. Then, the abnormal noise detection unit 35 compares the sound information collected by the operation sound collection unit 34 with the sound information in the normal state, to determine whether the collected sound information includes an abnormal noise. Furthermore, the abnormal noise detection unit 35 determines an abnormal noise level indicating the volume of the detected abnormal noise. Here, the abnormal noise level is an index a larger value of which indicating a louder sound. Regarding the abnormal noise level, various values indicating the volume of sound such as the amplitude value of the acquired abnormal noise data or the acquired sound pressure level [db] can be used as the index.

When the abnormal noise level of the abnormal noise detected by the abnormal noise detection unit 35 is larger than a preset threshold, the control unit 37 determines that the abnormal noise is produced and stores the collected sound information of the abnormal noise in the data storage unit 39. Then, the control unit 37 transmits the sound information of the abnormal noise stored in the data storage unit 39 to the management server 20 at a preset interval, for example, at an interval such as once a day.

When the abnormal noise detection unit 35 detects an abnormal noise, the control unit 37 identifies the cause of the abnormal noise. If the control unit 37 fails to identify the cause of the abnormal noise, the control unit 37 may transmit cause analysis data to an external server such as the management server 20. Then, a result of analysis by the external server, indicating a candidate of the cause of the abnormal noise analyzed may be returned to the image forming apparatus 10.

In a case where an abnormal noise at an abnormal noise level higher than a preset threshold is detected and the cause fails to be identified as a result of analysis of the cause of the abnormal noise but the abnormal noise is not produced again thereafter, the control unit 37 may determine that the detected abnormal noise is not an abnormal noise produced in the apparatus and is an abnormal noise produced by disturbance such as external vibration, impact, or the like, and determine that the abnormal noise is not produced.

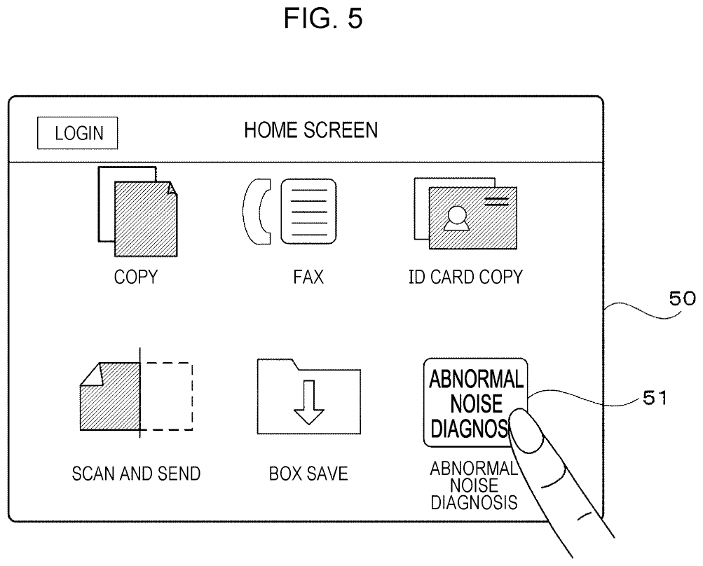

The image forming apparatus 10 according to the present exemplary embodiment has a function of performing abnormal noise diagnosis based on a user's instruction, in addition to the above-described normal abnormal noise detection. For example, as illustrated in FIG. 5, the control unit 37 displays an operation icon 51 named “abnormal noise diagnosis” on the operation panel 50 of the image forming apparatus 10, and executes a self-diagnosis function when the user operates the operation icon 51. FIG. 5 is an example of a home screen to be displayed on the operation panel 50 of the image forming apparatus 10.

As described above, the control unit 37 performs diagnosis regarding whether the abnormal noise is produced in the own apparatus based on the instruction from the user, identifies the cause of the abnormal noise when the abnormal noise is produced, and displays the cause on the operation panel 50 as the diagnosis result. Then, when the diagnosis result includes an indication that the abnormal noise is produced and the cause, the user receives a notification indicating that the cause of the abnormal noise is one that can be addressed without requiring the user operation, one that can be addressed by the user operation, or one that requires a countermeasure to be taken by the customer engineer.

Furthermore, if the cause of the abnormal noise is one that can be addressed without requiring the user operation, the control unit 37 executes a countermeasure to stop the abnormal noise after receiving the permission from the user.

Here, the cause that can be addressed without requiring user operation is a cause that can be self-repaired by the image forming apparatus 10. When the cause of the abnormal noise can be self-repaired, the control unit 37 executes self-repair processing to stop the abnormal noise. For example, in a case where oscillation of a bias charge roll (BCR) is the cause of the abnormal noise, self-repair processing such as adjusting a frequency of an AC voltage applied to the bias charge roll or decreasing a printing speed is executed. Further, in a case where the squeaking of a cleaner blade is the cause of the abnormal noise, the control unit 37 executes the self-repairing processing such that the cleaner blade is slightly reversely rotated to remove the paper powder deposited on the cleaner blade or a toner band is automatically drawn to attach the toner, to serve as lubricant, on the cleaner blade. In addition, in a case where the wind noise of a fan blade is the cause of the abnormal noise, the control unit 37 performs the self-repair processing such as decreasing the number of rotations of or stopping the rotation of a fan motor of a fan causing the abnormal noise. Note that the control unit 37 can identify the fan as the cause of the abnormal noise from the frequency of the abnormal noise produced, and may stop the rotation of the fan causing the abnormal noise, and instead increase the number of rotations of the other fans to keep the cooling capacity constant while addressing the cause of the abnormal noise.

Furthermore, the control unit 37 notifies the user of the fact that the abnormal noise has stopped upon confirming that the abnormal noise has been successfully stopped in the operation after the execution of the treatment for stopping the abnormal noise produced, and informs the CE of the production of the abnormal noise and asks the user whether to request a visit, upon failing to confirm that the abnormal noise has stopped.

Further, when the cause of the abnormal noise can be addressed by the user operation, the control unit 37 notifies the user of a countermeasure for stopping the abnormal noise. Specific examples of the cause of abnormal noise that can be addressed by the user operation and specific examples of the corresponding countermeasures to be instructed to the user are described in the following (1) to (7).
(1) When the detected abnormal noise is a paper burr sound, the control unit 37 instructs a user how to correctly set a paper guide in a paper feed tray. Alternatively, the user is notified of an instruction to first separate the sheets and then set the sheets again on the paper feed tray. Alternatively, the control unit 37 instructs the user to check whether the sheet set in the paper feed tray is wavy, and instructs the user to replace the sheet when the sheet is wavy.
(2) In a case where the falling sound of a bottom plate of the paper feed tray is the cause of the production of the abnormal noise, the control unit 37 instructs the user to check whether the sheets exceeding the upper limit of the number of storable sheets are stored in the paper feed tray.
(3) In a case where a tooth jump of a gear of an auger of a toner collection system in a toner conveyance mechanism, an abnormal noise of a bearing for driving the auger, or a step-out noise of a motor is the cause of the abnormal noise, the control unit 37 instructs a user to lightly stir and then reset the toner collection bottle or the toner storage bottle. If this cannot stop the abnormal noise, the control unit 37 instructs the user to replace the component causing the abnormal noise.
(4) In a case where bearing abnormal noise or blade squeak that frequently occurs in a high-temperature and high-humidity environment or bellows jam (sheet jam) in a fixing device is the cause of the abnormal noise produced, when a waveform of such an abnormal noise is detected and a temperature and humidity sensor in the apparatus indicates a value exceeding a predetermined threshold, the control unit 37 provides text information such as “Is stove or humidifier placed nearby? If so, move such devices away from the apparatus” on the operation panel 50.
(5) In a case where abnormal roll rushing sound or roll coming-out sound at the leading end or the trailing end of the roll is the cause of the abnormal noise, the control unit 37 displays text information such as “Is paper type setting of the paper feed tray in which the abnormal noise is produced correct?” on the operation panel 50.
(6) In a case where a foreign object such as a piece of paper is the cause of the abnormal noise and is at the location removable by the user to cause the abnormal noise, the control unit 37 displays how to remove the foreign object on the operation panel 50.
(7) In a case where the vibration of a cover such as a front door is the cause of the abnormal noise, the control unit 37 displays an instruction to firmly close the cover which is causing the abnormal noise on the operation panel 50.

Then, after displaying the countermeasure to be taken by the user as described above on the operation panel 50, the control unit 37 performs self-diagnosis to determine the presence or absence of the abnormal noise in the job to be executed first after detecting power ON/OFF or the interlock opening/closing. Note that in a case where the cause of the abnormal noise is the paper feed tray, the control unit 37 performs self-diagnosis to determine the presence or absence of the abnormal noise in a case where a job using the paper feed tray is executed. In addition, in a case where the cause of the abnormal noise a toner supply unit, the control unit 37 checks whether the abnormal noise is produced by rotating a color toner bottle causing the abnormal noise for a duration not affecting the density of the image to be printed.

In a case where the countermeasure for stopping the abnormal noise is instructed to the user, the control unit 37 notifies the user of the fact that the abnormal noise has been stopped when the abnormal noise is confirmed to be successfully stopped in the operation after the countermeasure has been taken by the user for stopping the abnormal noise, and asks the user if he or she wishes to contact the CE and request for the visit for the abnormal noise produced when it cannot be confirmed that the abnormal noise has stopped.

Note that when the user fails to stop the abnormal noise and selects to request for the visit by the CE, the control unit 37 transmits the collected information on the abnormal noise and a message indicating that the user has requested for the visit by the CE to the management server 20 installed in the call center.

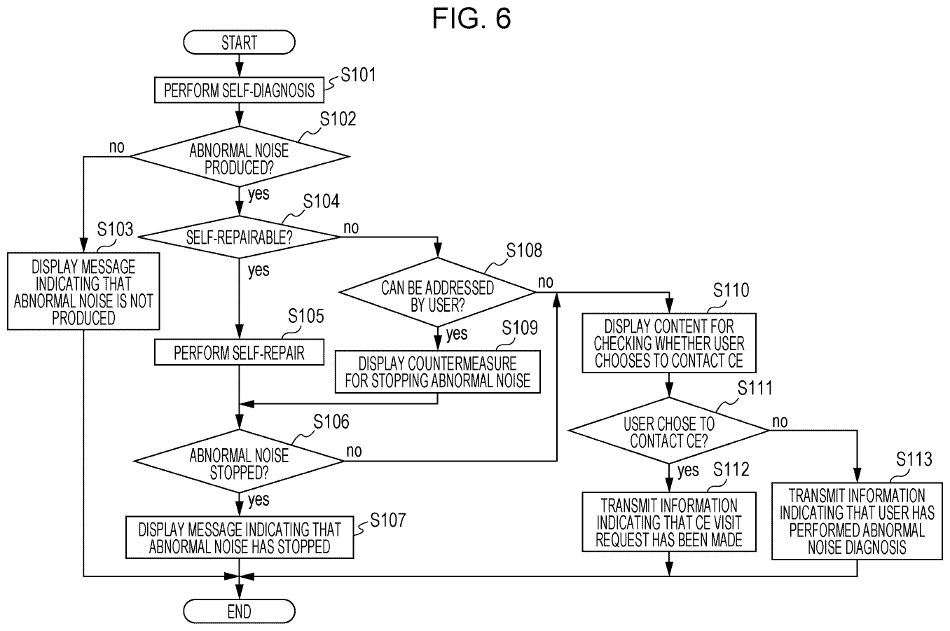

Next, an operation in a case where the operation icon 51 “abnormal noise diagnosis” is operated on the home screen as illustrated in FIG. 5 and the self-diagnosis regarding the presence or absence of the abnormal noise is performed will be described with reference to a flowchart in FIG. 6.

When the operation icon 51 “abnormal noise diagnosis” is operated on the home screen as illustrated in FIG. 5 and an instruction to perform a self-diagnosis from the user is accepted, the control unit 37 performs a self-diagnosis regarding the presence or absence of abnormal noise in step S101 and determines, in step S102, whether the abnormal noise has been detected by the abnormal noise detection unit 35 within a past predetermined period.

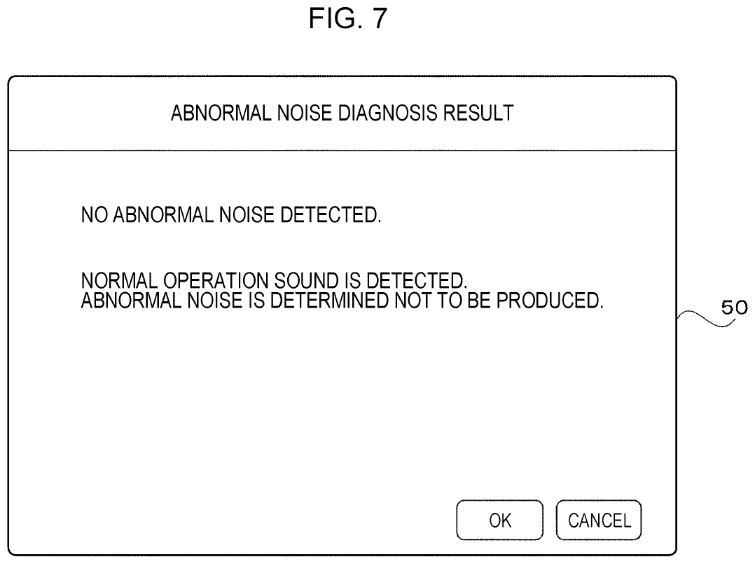

When it is determined in step S102 that no abnormal noise is detected within the past predetermined period, the control unit 37 displays, on the operation panel 50, a message indicating that no abnormal noise is produced in step S103. FIG. 7 illustrates an example of a display screen in a case where a message indicating that no abnormal noise is produced is displayed on the operation panel 50. Referring to FIG. 7, the operation panel 50 in a state of displaying text information “No abnormal noise detected.”, “Normal operation sound is detected. abnormal noise is determined not to be produced.” is illustrated.

Upon determining in step S102 that the abnormal noise is detected within the past predetermined period, the control unit 37 determines in step S104, based on the cause of the detected abnormal noise, whether the cause can be addressed by the self-repair.

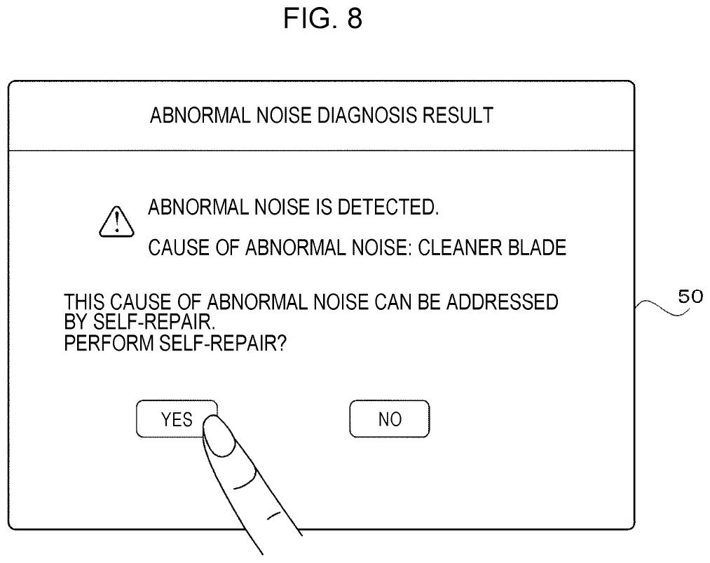

Next, upon determining that the cause of the abnormal noise detected in step S104 is self-repairable, the control unit 37 performs self-repair in step S105. Alternatively, the control unit 37 may display a display screen as illustrated in FIG. 8 on the operation panel 50 and perform the self-repair when the user gives permission to perform the self-repair. FIG. 8 is a diagram illustrating an example of a display screen that is displayed in a case where the abnormal noise is detected and the cause of the detected abnormal noise is self-repairable.

The display screen example illustrated in FIG. 8 is a case where text information including “abnormal noise is detected.” and a message indicating that the cause of the abnormal noise is “cleaner blade” are displayed, and the user selects “Yes” to give permission to perform the self-repair.

Then, when the print job is performed for the first time after the self-repair is performed, the control unit 37 determines whether the abnormal noise has stopped in step S106.

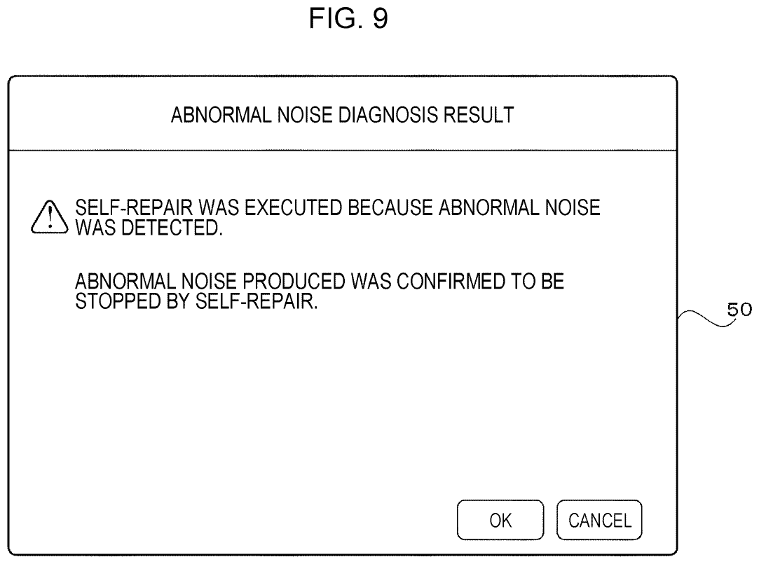

Upon determining in step S106 that the abnormal noise has stopped, the control unit 37 displays, in step S107, a message indicating that the abnormal noise has stopped on the operation panel 50. FIG. 9 illustrates an example of a display screen thus displayed. As can be seen in FIG. 9, text information “Self-repair was executed because abnormal noise was detected. Abnormal noise produced was confirmed to be stopped by self-repair.”.

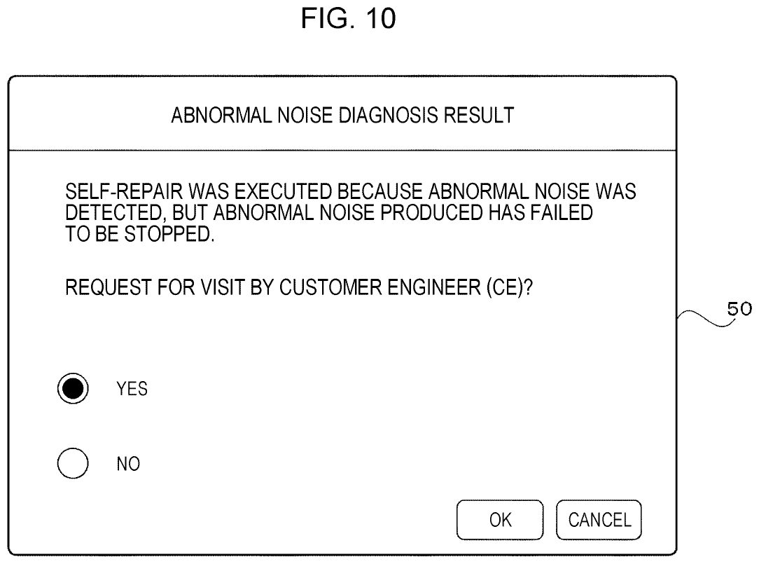

Upon determining in step S106 that the abnormal noise has failed to be stopped, in step S110, the control unit 37 displays, on the operation panel 50, a content asking the user whether to contact the CE and request a visit. FIG. 10 illustrates an example of a display screen thus displayed. It can be seen in FIG. 10 that text information “Self-repair was executed because abnormal noise was detected, but abnormal noise produced has failed to be stopped. Request for visit by customer engineer (CE)?”.

Next, in step S111, the control unit 37 determines whether the user has chosen to contact the CE to request for a visit. Specifically, when the user selects “Yes” and operates the OK button on the display screen illustrated in FIG. 10, the control unit 37 determines that the user has chosen to contact the CE to request for a visit. When the user selects “No” and operates the OK button on the display screen illustrated in FIG. 10, the control unit 37 determines that the user has not chosen to contact the CE to request for a visit.

Upon determining in step S111 that the user has chosen to contact the CE to request for a visit, the control unit 37 transmits, in step S112, a visit request to the CE together with the sound information of the detected abnormal noise to the management server 20 installed in the call center.

Upon determining in step S111 that the user has not chosen to contact the CE to request for a visit, the control unit 37 transmits an indication that the user has performed the abnormal noise diagnosis, that is, indication that the user has performed the abnormal noise diagnosis and sound information on the detected abnormal noise to the management server 20 installed in the call center in step S113.

Furthermore, upon determining in step S104 that the cause of the abnormal noise detected is self-repairable, the control unit 37 determines, in step S108, whether the cause of the abnormal noise detected can be addressed by the user.

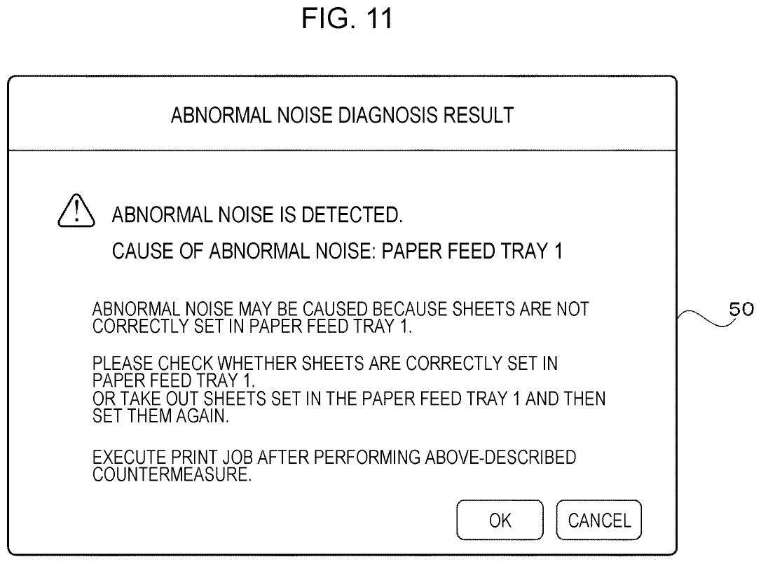

Upon determining that the cause of the abnormal noise detected in step S108 can be addressed by the user, the control unit 37 notifies the user of a countermeasure for stopping the abnormal noise by displaying the countermeasure on the operation panel 50 in step S109. FIG. 11 illustrates an example of a display screen thus displayed. As can be seen in FIG. 11, text information “Abnormal noise is detected.” as well as an estimated cause of the abnormal noise and a countermeasure for stopping the abnormal noise are displayed.

Then, when the print job is performed for the first time after the countermeasure has been taken by the user to stop the abnormal noise, the control unit 37 determines whether the abnormal noise has stopped in step S106.

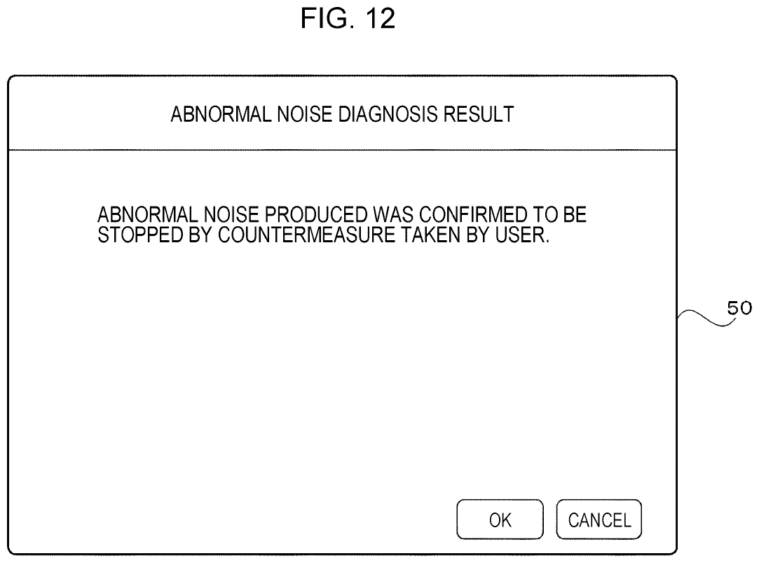

Upon determining in step S106 that the abnormal noise has stopped, the control unit 37 displays, in step S107, a message indicating that the abnormal noise has stopped on the operation panel 50. FIG. 12 illustrates an example of a display screen thus displayed. It can be seen in FIG. 12 that text information “Abnormal noise produced was confirmed to be stopped by countermeasure taken by user.”.

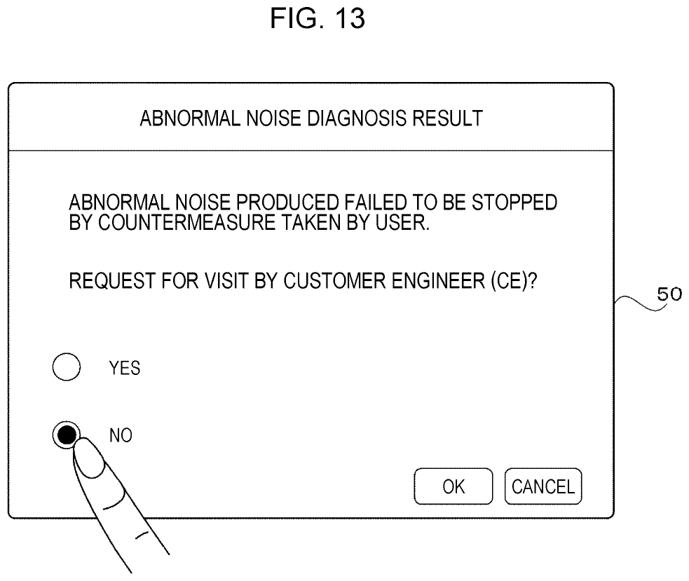

Upon determining that the abnormal noise has failed to be stopped even when the countermeasure has been taken by the user in step S106, in step S110, the control unit 37 displays, on the operation panel 50, a message asking the user whether to contact the CE to request for a visit. FIG. 13 illustrates an example of a display screen thus displayed. As can be seen in FIG. 13, text information “Abnormal noise produced failed to be stopped by countermeasure taken by user. Request for visit by customer engineer (CE)?”.

Next, in step S111, the control unit 37 determines whether the user has chosen to contact the CE to request for a visit. Note that since the same processing as that described as the processing after the self-repair is performed as described above is executed as the processing after step S111, the description thereof will be omitted. In the display screen example in FIG. 13, an operation example in a case where the user has not chosen to contact the CE to request for a visit is illustrated.

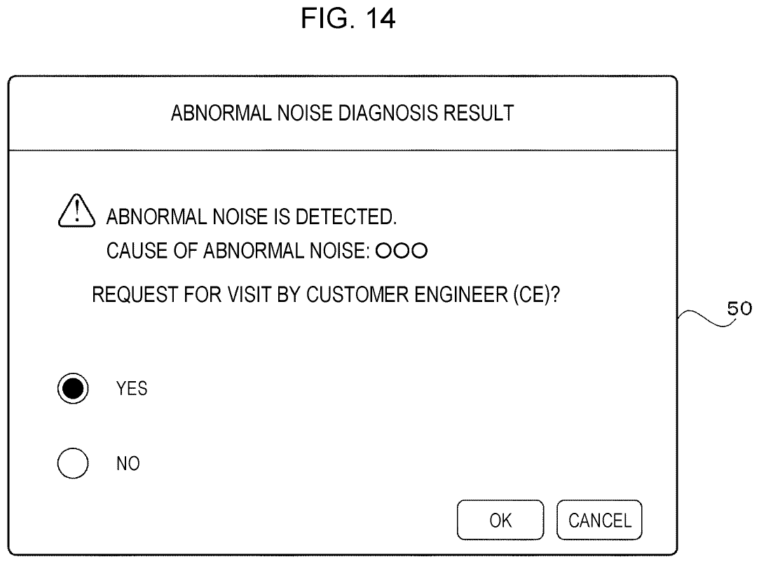

Upon determining in step S108 that the cause of the abnormal noise detected cannot be addressed by the user, in step S111, the control unit 37 displays, on the operation panel 50, a content for checking whether the user wishes to contact the CE to request for a visit. FIG. 14 illustrates an example of a display screen thus displayed. As can be seen in FIG. 14, text information “Abnormal noise is detected. Request for visit by customer engineer (CE)?” is displayed. In this case, since the cause of the abnormal noise is not self-repairable and cannot be addressed by the user, the control unit 37 simply provides a display indicating that the abnormal noise has been detected and the estimated cause of the abnormal noise, and checks whether the user wishes to request for a visit by the CE.

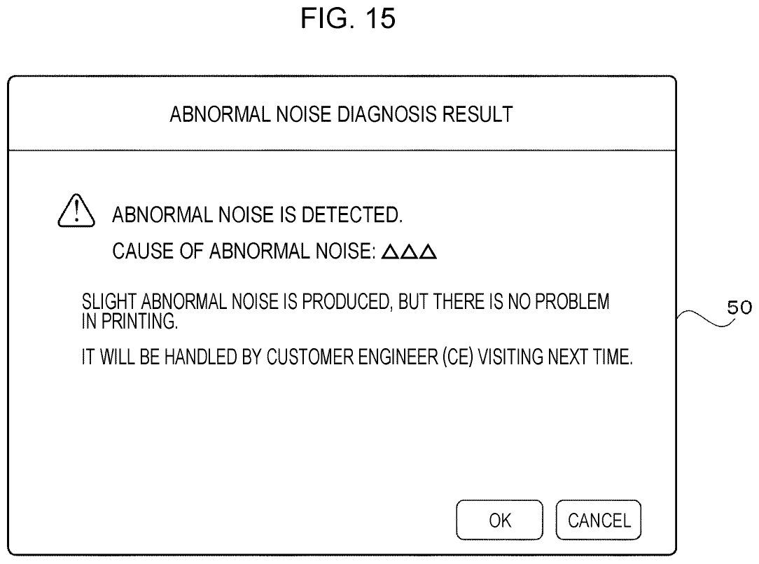

Upon determining that the cause of the detected abnormal noise is not self-repairable and cannot be addressed by the user, but the abnormal noise is a slight noise with a low abnormal noise level not leading to a failure, the control unit 37 may display a display screen as illustrated in FIG. 15 on the operation panel 50. As can be seen in the display screen example in FIG. 15, text information “Abnormal noise is detected” as well as information on estimated cause of the abnormal noise and text information “Slight abnormal noise is produced, but there is no problem in printing. It will be handled by customer engineer (CE) visiting next time” are displayed.

Note that upon determining that the detected cause of the abnormal noise is not self-repairable and cannot be addressed by the user, and may lead to a serious failure such as that related to an expensive component or ejection of toner, the control unit 37 may display on the operation panel 50, text information “Abnormal noise is produced. Call center will be notified”. In this case, the control unit 37 immediately transmits, to the management server 20, an indication that an abnormal noise is produced and an indication that an immediate action needs to be taken together with the estimated cause of the abnormal noise, without requiring confirmation by the user.

Note that in the determination threshold for the abnormal noise detection unit 35 to determine whether the normal sound or abnormal noise is produced may be changeable using the operation input unit 32 or remotely from the management server 20. Alternatively, the threshold may be automatically adjusted based on the volume level of the sound in the environment in which the image forming apparatus 10 is installed, or may be automatically updated by a remote operation for each apparatus based on the cause of the abnormal noise in the image forming apparatus 10 for which a claim has been made in the past and the volume level at that time.

The diagnosis result of the self-diagnosis for the abnormal noise as described above may be displayed not only on the operation panel 50 but may also be displayed on a display screen of a terminal device such as a mobile terminal device or a personal computer connected to the image forming apparatus 10 using a wired or wireless communication line.

In the above exemplary embodiment, the processor refers to a processor in a broad sense, and includes a general-purpose processor (such as, for example, a central processing unit (CPU)) and a dedicated processor (such as, for example, a graphics processing unit (GPU), an application specific integrated circuit (ASIC), a field programmable gate array (FPGA), or a programmable logic device).

The operation of the processor in the above-described exemplary embodiment may be performed not only by one processor but also through cooperation between a plurality of processors located at physically separated positions. Furthermore, the order of the operations of the processor is not limited to the order described in the above exemplary embodiment only, and may be appropriately changed.

The “system” in the present exemplary embodiment includes both a system configured by a plurality of apparatuses and a system configured by a single apparatus.

### Modifications

While the case where the monitoring target apparatus is an image forming apparatus is described in the above exemplary embodiment, the present disclosure is not limited thereto. The present disclosure can be similarly applied to a case where a processing apparatus other than an image forming apparatus is the monitoring target apparatus, as long as it is an apparatus producing abnormal noise in a case where a malfunction occurs, that is, for example, a processing apparatus executing various types of processing through operations of components such as a motor, a roller, and a fan.

### APPENDIX

(((1)))

An information processing system comprising a processor configured to:
perform diagnosis regarding whether an abnormal noise is produced in the information processing system based on an instruction from a user;
identify a cause of the abnormal noise when the abnormal noise is produced, and display the cause as a result of the diagnosis; and
when the diagnosis result includes an indication that the abnormal noise is produced and the cause, notify the user of an indication that the cause of the abnormal noise is able to be addressed without requiring an operation of the user, is able to be addressed through the operation of the user, or requires a countermeasure to be taken by a customer engineer.
(((2)))

The information processing system according to (((1))), wherein, in a case where the cause of the abnormal noise is a cause that is able to be addressed without requiring an operation of the user, the processor is configured to execute processing for stopping the abnormal noise produced, after receiving permission from the user.
(((3)))

The information processing system according to (((2))), wherein the processor is configured to notify the user of a fact that the abnormal noise has stopped when the abnormal noise is confirmed to be stopped in an operation performed after the processing for stopping the abnormal noise produced, and ask the user whether to inform the customer engineer of the production of the abnormal noise when the abnormal noise has failed to be confirmed to be stopped.
(((4)))

The information processing system according to (((1))), wherein the processor is configured to notify the user of a countermeasure for stopping the abnormal noise in a case where the cause of the abnormal noise is able to be addressed by an operation by the user.
(((5)))

The information processing system according to (((4))), wherein the processor is configured to notify the user of a fact that the abnormal noise has stopped when the abnormal noise is confirmed to be stopped in an operation performed after the countermeasure has been taken by the user to stop the abnormal noise, and ask the user whether to inform the customer engineer of the production of the abnormal noise when the abnormal noise has failed to be confirmed to be stopped.
(((6)))

A program causing a computer to execute a process comprising:

performing diagnosis regarding whether an abnormal noise is produced in a corresponding system based on an instruction from a user, identifies a cause of the abnormal noise when the abnormal noise is produced, and displaying the cause as a result of the diagnosis; and

notifying, when the diagnosis result includes an indication that the abnormal noise is produced and the cause, the user of an indication that the cause of the abnormal noise is able to be addressed without requiring an operation of the user, is able to be addressed through the operation of the user, or requires countermeasure to be taken by a customer engineer.

What is claimed is:

1. An information processing system comprising a processor configured to:
perform diagnosis regarding whether an abnormal noise is produced in the information processing system based on an instruction from a user;
identify a cause of the abnormal noise when the abnormal noise is produced, and display the cause as a result of the diagnosis; and
when the diagnosis result includes an indication that the abnormal noise is produced and the cause, notify the user of an indication that the cause of the abnormal noise is able to be addressed without requiring an operation of the user, is able to be addressed through the operation of the user, or requires a countermeasure to be taken by a customer engineer.

2. The information processing system according to claim 1, wherein, in a case where the cause of the abnormal noise is a cause that is able to be addressed without requiring an operation of the user, the processor is configured to execute processing for stopping the abnormal noise produced, after receiving permission from the user.

3. The information processing system according to claim 2, wherein the processor is configured to notify the user of a fact that the abnormal noise has stopped when the abnormal noise is confirmed to be stopped in an operation performed after the processing for stopping the abnormal noise produced, and ask the user whether to inform the customer engineer of the production of the abnormal noise when the abnormal noise has failed to be confirmed to be stopped.

4. The information processing system according to claim 1, wherein the processor is configured to notify the user of a countermeasure for stopping the abnormal noise in a case where the cause of the abnormal noise is able to be addressed by an operation by the user.

5. The information processing system according to claim 4, wherein the processor is configured to notify the user of a fact that the abnormal noise has stopped when the abnormal noise is confirmed to be stopped in an operation performed after the countermeasure has been taken by the user to stop the abnormal noise, and ask the user whether to inform the customer engineer of the production of the abnormal noise when the abnormal noise has failed to be confirmed to be stopped.

6. A non-transitory computer readable medium causing a computer to execute a process comprising:
performing diagnosis regarding whether an abnormal noise is produced in a corresponding system based on an instruction from a user, identifies a cause of the abnormal noise when the abnormal noise is produced, and displaying the cause as a result of the diagnosis; and
notifying, when the diagnosis result includes an indication that the abnormal noise is produced and the cause, the user of an indication that the cause of the abnormal noise is able to be addressed without requiring an operation of the user, is able to be addressed through the operation of the user, or requires countermeasure to be taken by a customer engineer.
